(19) United States
(12) Patent Application Publication
(10) Pub. No.: US 2013/0100336 A1
(43) Pub. Date: Apr. 25, 2013

(54) CAMERA SYSTEM AND CAMERA BODY

(71) Applicant: Panasonic Corporation, Osaka (JP)

(72) Inventor: Dai SHINTANI, Osaka (JP)

(73) Assignee: Panasonic Corporation, Osaka (JP)

(21) Appl. No.: 13/653,555

(22) Filed: Oct. 17, 2012

(30) Foreign Application Priority Data
Oct. 21, 2011 (JP) 2011-231399

(51) Int. Cl. H04N 5/232

(52) U.S. Cl. 348/345; 348/E05.045

(57) ABSTRACT

There is provided a camera system with which, when an interchangeable lens capable of electrical zooming has been mounted, the electrical zoom can be operated from the camera body side without sacrificing the function of the camera body. This camera system comprises a lens unit with which the zoom ratio of an optical image can be varied electrically, and a camera body having a body mount with which the lens unit can be attached and removed, a self-centering manipulation member, and a camera controller that controls the lens unit so as to vary the zoom ratio of an optical image electrically.

### BACKGROUND

1. Technical Field

The technical field relates to an interchangeable lens type of camera system and camera body that allow lens replacement.

2. Description of the Related Art

Digital cameras that use a CCD (charge coupled device) image sensor, CMOS (complementary metal oxide semiconductor) image sensor, or other such imaging element to convert a subject image into an electrical signal, and digitally record this electrical signal, have become popular in recent years.

With so-called digital single-lens reflex cameras, digital range finder cameras, and so forth that allow lens replacement, it is becoming possible to capture moving pictures. However, the zooming interchangeable lenses made up to now whose purpose was the capture of still pictures involved rotary optical zooming by hand, or rectilinear optical zooming by hand, so it was extremely difficult to perform smooth zooming or zooming at a constant rate during moving picture capture.

Therefore, there has been a need for electrical optical zooming with a favorable zooming interchangeable lens.

With the conventional camera discussed in Patent Literature 1, when the interchangeable lens unit is compatible with electrical zoom, the electrical zoom manipulation function is assigned to a cross key that already exists on the camera body and handles imaging functions other than electrical zoom, and if the interchangeable lens unit is compatible with electrical manual focus, the focus manipulation function is assigned to the cross key that already exists on the camera body and handles imaging functions other than electrical zoom.

### PATENT LITERATURE

Patent Literature 1: International Laid-Open Patent Application 2009/041063

### SUMMARY

With the conventional camera in Patent Literature 1, however, when an interchangeable lens unit compatible with electrical zoom is mounted, a problem is encountered in that the functions assigned to the existing cross key cannot be used.

This disclosure provides an interchangeable lens type of camera system and camera body with which electrical zooming can be performed from the camera body side, without any loss of camera body functions, when an interchangeable lens capable of electrical optical zoom has been mounted.

This disclosure also provides an interchangeable lens type of camera system and camera body with which electronic zooming can be performed from the camera body side, without any loss of camera body functions, when an interchangeable lens with which the zoom ratio of an optical image is fixed or can be varied manually has been mounted.

One of the above objects is achieved by the following camera system. Specifically, this disclosure relates to a camera system comprising:

a lens unit with which the zoom ratio of an optical image can be varied electrically; and

a camera body having a mount that allows the lens unit to be attached and removed, a self centering camera body manipulation component, and a camera body controller that controls the lens unit so as to vary the zoom ratio of an optical image electrically according to the operation of the camera body manipulation component in a state in which the lens unit has been mounted to the mount.

Another of the above objects is achieved by the following camera system. Specifically, this disclosure relates to a camera system comprising:

a lens unit with which the zoom ratio of an optical image is fixed or can be varied manually; and

a camera body having a mount that allows the lens unit to be attached and removed, a self-centering camera body manipulation component, an imaging element that produces image data by converting an optical image produced by the lens unit into an electrical signal, and a camera body controller that can perform electronic zooming to crop part of the image data, and that controls so as to continuously vary the zoom ratio of the electronic zooming of the image data according to the operation of the camera body manipulation component, in a state in which the lens unit has been mounted to the mount.

Another of the above objects is achieved by the following camera system. Specifically, this disclosure relates to a camera system comprising: a lens unit with which the zoom ratio of an optical image can be varied electrically; a mount that allows the lens unit to be attached and removed; a camera body having at least one camera body manipulation component capable of reciprocating movement; a selection means for selecting the function of the camera body manipulation component; and a controller that controls the lens unit in a state in which the lens unit has been mounted to the mount, wherein the controller controls the lens unit so as to vary the zoom ratio of an optical image electrically according to the operation of the camera body manipulation component when the camera body manipulation component has been assigned a zoom function.

Another of the above objects is achieved by the following camera system. Specifically, this disclosure relates to a camera system comprising: a lens unit with which the zoom ratio of an optical image can be varied manually; a mount that allows the lens unit to be attached and removed; a camera body having an imaging element that converts an optical image formed by the lens unit into an electrical signal; at least one a camera body manipulation component on the camera body capable of reciprocating movement; a selection means for selecting the function of the camera body manipulation component from among a plurality of functions; and a controller that controls the camera body in a state in which the lens unit has been mounted to the mount; wherein the controller controls the camera body so as to vary the zoom ratio of an optical image by electronic zooming in which part of an optical image formed by the imaging element is continuously cropped, according to the operation of the camera body manipulation component.

Another of the above objects is achieved by the following camera system. Specifically, this disclosure relates to a camera system comprising: a lens unit having a specific focal distance; a mount that allows the lens unit to be attached and removed; a camera body having an imaging element that converts an optical image formed by the lens unit into an electrical signal; at least one a camera body manipulation component on the camera body capable of reciprocating movement; a selection means for selecting the function of the camera body manipulation component from among a plurality of functions; and a controller that controls the camera body in a state in which the lens unit has been mounted to the mount; wherein the controller controls the camera body so as to vary the zoom ratio of an optical image by electronic zooming in which part of an optical image formed by the imaging element is continuously cropped, according to the operation of the camera body manipulation component.

Another of the above objects is achieved by the following camera body. Specifically, this disclosure relates to a camera body having an imaging component that captures a subject image and is used in a camera system for capturing images of the subject, a mount that allows an electrical zoom lens unit, a manual zoom lens unit, or a single-focus lens unit to be attached and removed, a lens unit identifier that detects the type of the lens unit in a state in which one of these lens units has been mounted to the mount, and a controller that controls a plurality of zoom methods; wherein the camera body comprises a zoom manipulation component with which the zoom ratio of an optical image formed by the lens unit can be varied.

Another of the above objects is achieved by the following camera body. Specifically, this disclosure relates to a camera body including: an imaging component that is used in a camera system for capturing subject images and that captures images of the subject; a main body controller that controls the imaging operation of the imaging component; a mount that allows a lens unit to be attached and removed; at least one camera body manipulation component capable of reciprocating movement; and a selection means for selecting the function of the camera body manipulation component from among a plurality of functions, wherein the camera body comprises display means for displaying the function selected by the selection means.

With the camera system and camera body in this disclosure, when an interchangeable lens is mounted that allows optical zooming to be performed electrically, the electrical zooming can be performed from the camera body side without a loss of any of the functions of the camera body.

Also, with the camera system and camera body in this disclosure, when an interchangeable lens is mounted with which the zoom ratio of an optical image is fixed or can be varied manually, electronic zooming can be performed from the camera body side without a loss of any of the functions of the camera body.

### BRIEF DESCRIPTION OF DRAWINGS

FIG. 1 is an oblique view of a camera system 1 in Embodiment 1;

FIG. 2 is an oblique view of a camera body 100 in Embodiment 1;

FIG. 3 is a block diagram of the camera system 1 in Embodiment 1;

FIG. 4 is a simplified cross section of the camera system 1 in Embodiment 1;

FIG. 5 is a rear view of the camera body 100 in Embodiment 1;

FIG. 6 is a rear view of the camera body 100 in Embodiment 1;

FIG. 7 is a simplified cross section of a camera system 2 in Embodiment 1;

FIG. 8 is a simplified cross section of a camera system 3 in Embodiment 1;

FIG. 9 is a rear view of the camera body 100 in another embodiment; and

FIG. 10 is a rear view of the camera body 100 in another embodiment.

### DETAILED DESCRIPTION OF THE PREFERRED EMBODIMENTS

The camera system and camera body pertaining to preferred embodiments of this disclosure will now be described through reference to the drawings as necessary. However, unnecessarily detailed description may be omitted in some cases. For example, duplicated description of components that are substantially the same may be omitted. The reason for this is to avoid making the following description unnecessarily redundant, and to facilitate an understanding on the part of a person skilled in the art.

Furthermore, the appended drawings and the following description are provided so that a person skilled in the art will thoroughly understand this disclosure without intending to limit the scope of the claims.

### Embodiment 1

### 1: Configuration

Overview of Camera System

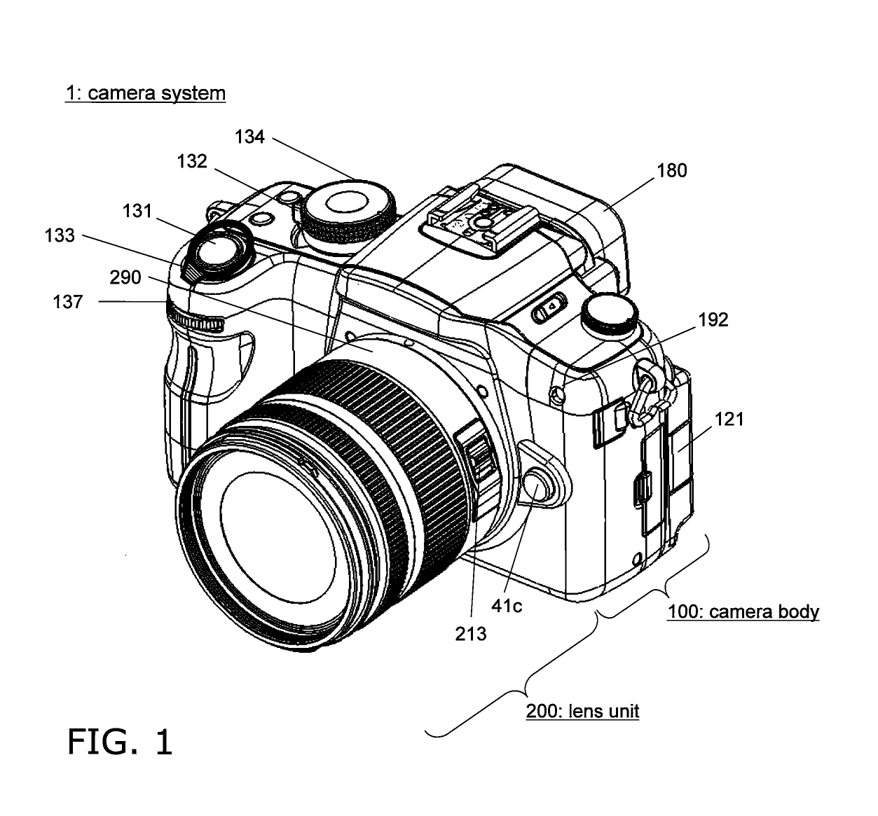

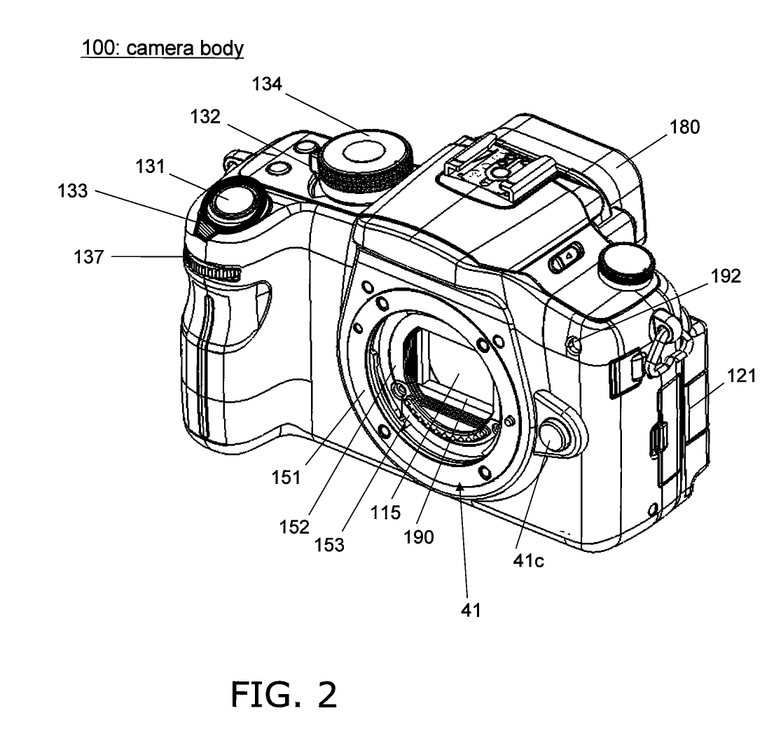

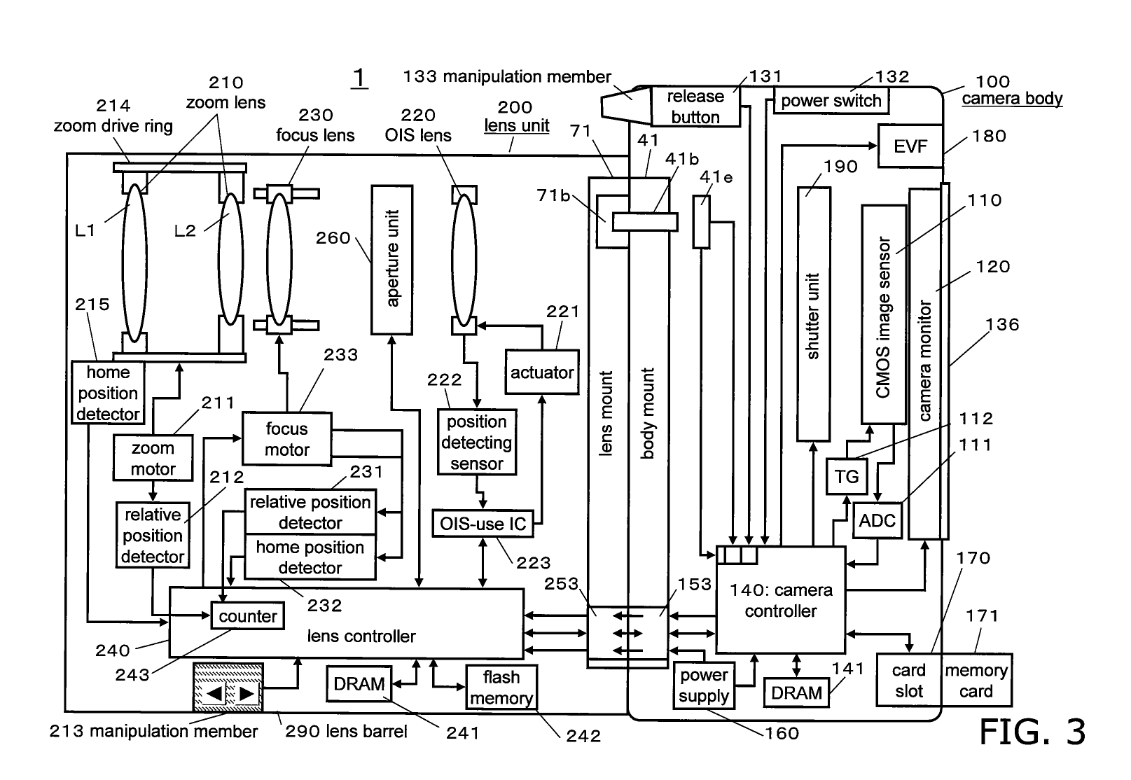

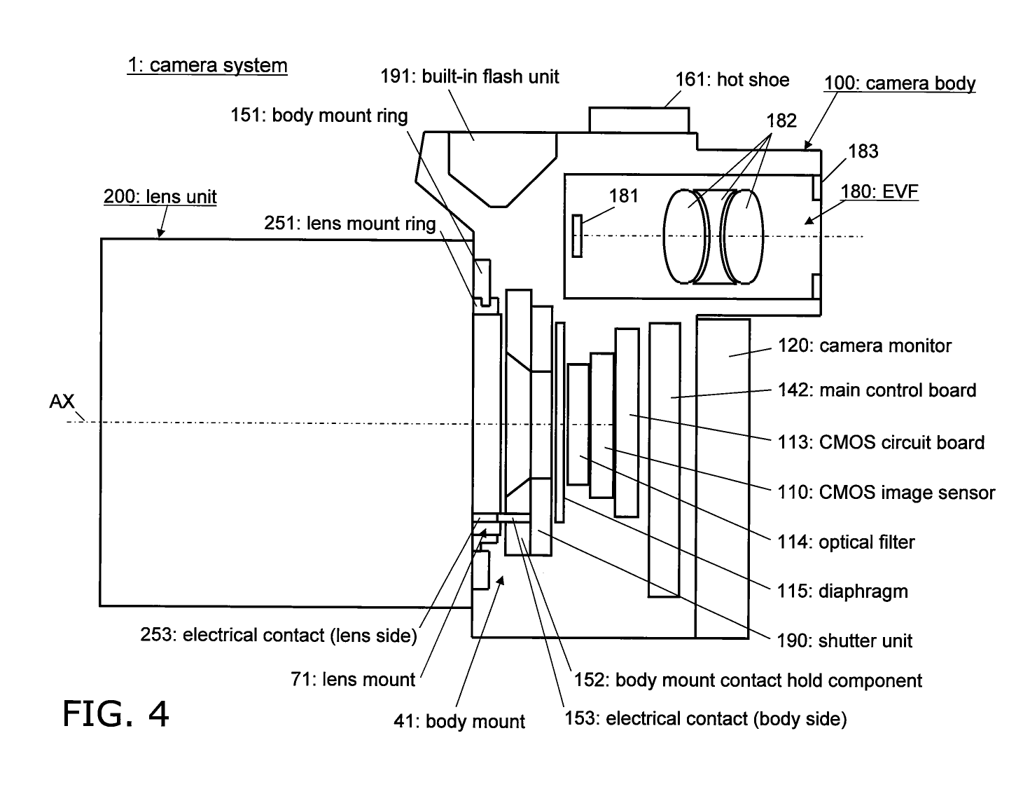

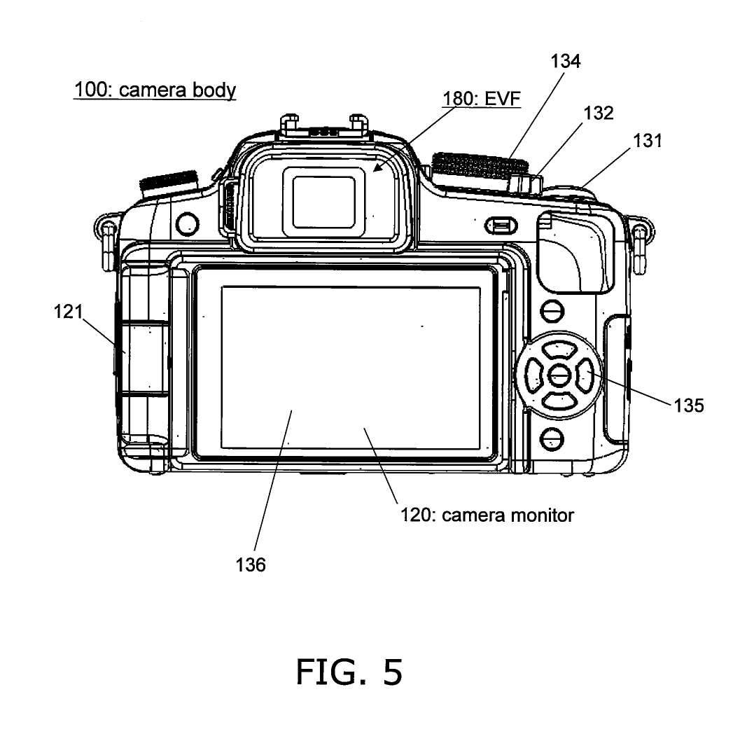

FIG. 1 is an oblique view of the camera system 1 pertaining to Embodiment 1 of this disclosure. The camera system 1 is made up of a camera body 100 and a lens unit 200 that can be attached to and removed from the camera body 100. FIG. 2 is an oblique view of the camera body 100. FIG. 3 is a functional block diagram of the camera system 1. FIG. 4 is a simplified cross section of the camera system 1. And FIG. 5 is a rear view of the camera body 100.

The various components will now be described in detail. For the sake of this description, the subject side of the camera system 1 will be referred to as the front, the imaging plane side as the back or rear, the vertically upper side when the camera system 1 is in its normal orientation as the top, and the vertically lower side as the bottom.

### 1-2: Configuration of Camera Body

The camera body 100 mainly comprises a CMOS image sensor 110, a CMOS circuit board 113, a camera monitor 120, various manipulation components 131 to 136, a main control board 142 that includes a camera controller 140, a body mount 41, a power supply 160, a card slot 170, an electronic viewfinder 180, a shutter unit 190, an optical filter 114, and a diaphragm 115. The camera body 100 has no mirror box apparatus. Also, as shown in FIGS. 3 and 4, the body mount 41, the shutter unit 190, the diaphragm 115, the optical filter 114, the CMOS image sensor 110, the CMOS circuit board 113, the main control board 142, and the camera monitor 120 are disposed in that order, starting from the front, on the camera body 100.

The CMOS image sensor 110 shown in FIGS. 3 and 4 produces image data by capturing an optical image of a subject that is incident through the lens unit 200. The CMOS image sensor 110 has an opto-electrical conversion layer in which are arranged a plurality of pixels capable of storing a charge through opto-electrical conversion, and a color filter layer in which a blue color filter that transmits only blue light, a green color filter that transmits only green light, and a red color filter that transmits only red light are arranged in a one-on-one correspondence with the pixels on the front face of the pixels. The CMOS image sensor 110 can amplify signals from pixels where blue color filters are disposed, signals from pixels where green color filters are disposed, and signals from pixels where red color filters are disposed. The CMOS image sensor 110 produces image data on the basis of these signals.

The image data that is produced is digitized by the A/D converter 111 shown in FIG. 3. The image data digitized by the A/D converter 111 is subjected to various image processing by the camera controller 140. The various image processing referred to here includes, for example, gamma correction processing, white balance correction processing, scratch correction processing, YC conversion processing, electronic zoom processing, and JPEG compression processing.

The CMOS image sensor 110 operates at a timing controlled by a timing generator 112 (see FIG. 3). The CMOS image sensor 110 performs the capture of still pictures, the capture of moving pictures, and so forth. The capture of moving pictures includes the capture of a through-image. A “through-image” here is an image that is not recorded to a memory card 171 after the capture of a moving picture. Through-images are primarily moving pictures, and are displayed on the camera monitor 120 and/or the electronic viewfinder (hereinafter also referred to as EVF) 180 to determine the composition of a moving or still picture (see FIGS. 3 and 5). The capture of moving pictures also includes the recording of moving pictures. The “recording of moving pictures” is an operation that includes the capture of moving pictures and the recording of moving picture data to the memory card 171. The CMOS image sensor 110 is an example of an imaging element that captures an optical image of a subject and converts it into an electrical image signal. The imaging element is a concept that encompasses a CCD image sensor and the like.

The CMOS circuit board 113 shown in FIG. 4 is a circuit board that controls the drive of the CMOS image sensor 110. The CMOS circuit board 113 is also a circuit board that subjects image data from the CMOS image sensor 110 to specific processing. The CMOS circuit board 113 includes the timing generator 112 shown in FIG. 3. The CMOS circuit board 113 also includes the A/D converter 111 shown in FIG. 3. The CMOS circuit board 113 is an example of an imaging element circuit board that controls the drive of the imaging element and/or subjects the image data from the imaging element to A/D conversion and other such specific processing.

The camera monitor 120 shown in FIGS. 3 to 5 displays an image indicated by display-use image data, etc. The display-use image data is produced by the camera controller 140 shown in FIG. 3. The display-use image data is image data that has undergone image processing, data for displaying the photography conditions of the camera system 1, an operation menu, etc., as an image, or the like. The camera monitor 120 is capable of selectively displaying both moving and still pictures. The camera monitor 120 has a liquid crystal display.

As shown in FIGS. 3 and 5, a touch panel 136 is integrally fixed to the surface of the camera monitor 120, and various kinds of information or operation displays that are displayed on the camera monitor 120 can be manipulated by touching them with a finger.

The camera monitor 120 is provided to the camera body 100. In this embodiment, the camera monitor 120 is disposed on the rear face of the camera body 100, but may be disposed anywhere on the camera body. The camera monitor 120 allows the angle of the display screen to be varied with respect to the camera body 100. More specifically, as shown in FIGS. 1 and 5, the camera body 100 has a hinge 121 between the camera body 100 and the camera monitor 120. The hinge 121 is disposed at the left end of the camera body 100. More specifically, the hinge 121 has a first hinge and a second hinge. More specifically, the camera monitor 120 is able to rotate to the left and right around the first hinge, and is able to rotate up and down around the second hinge.

The camera monitor 120 is an example of a display component provided to the camera body 100. Other examples of a display component include an organic electroluminescence component, an inorganic electroluminescence component, a plasma display panel, and other such devices that allow images to be displayed. The display component need not be disposed on the rear face of the camera body 100, and may instead be provided to a side face, the top face, or another such place.

The EVF 180 displays the image indicated by the display-use image data produced by the camera controller 140, etc. The EVF 180 is capable of selectively displaying both moving and still pictures. The EVF 180 and the camera monitor 120 may display the same or different content, and both are controlled by the camera controller 140. As shown in FIG. 4, the EVF 180 has an EVF-use liquid crystal monitor 181 that displays images and the like, an EVF-use optical system 182 that enlarges the display of the EVF-use liquid crystal monitor, and an eyepiece 183 up to which the user puts an eye.

The EVF 180 is also an example of a display component. The EVF 180 differs from the camera monitor 120 in that the user puts an eye up to it. The difference in terms of structure is that whereas the EVF 180 has the eyepiece 183, the camera monitor 120 does not have an eyepiece 183.

With the EVF-use liquid crystal monitor 181, a back light (not shown) is provided in the case of a transmission type of liquid crystal, and a front light (not shown) is provided in the case of a reflection type of liquid crystal, which ensures the proper display brightness, etc. The EVF-use liquid crystal monitor 181 is an example of an EVF-use monitor. The EVF-use monitor can be an organic electroluminescence component, and inorganic electroluminescence component, a plasma display panel, or any other such device that can display images. There is no need for an illumination light source in the case of an organic electroluminescence component or other such self-emitting device.

The manipulation components 131 to 136 shown in FIGS. 1 and 5 are operated by the user. The manipulation components include a release button 131, a power switch 132, a manipulation member 133, a rotary manipulation member 134, a cross key 135, and the touch panel 136. The release button 131 used for shutter operation by the user. The power switch 132 is a rotary dial switch provided to the top face of the camera body 100. The power is off in a first rotation position, and the power is on in a second rotation position. The rotary manipulation members 134 and 137 are endless rotary manipulation members, and allow the selection of various functions and the changing of parameters while the user looks at the display on the camera monitor 120 or the EVF 180. For example, the imaging mode (portrait imaging mode, landscape imaging mode, etc.) can be selected with the rotary manipulation member 134, and the shutter speed and so forth can be selected with the rotary manipulation member 137. The cross key 135 is a push switch in the form of keys to which various functions are assigned. The touch panel 136 is a manipulation member with which the various functions and parameters displayed on the camera monitor 120 can be changed by touching it with a finger.

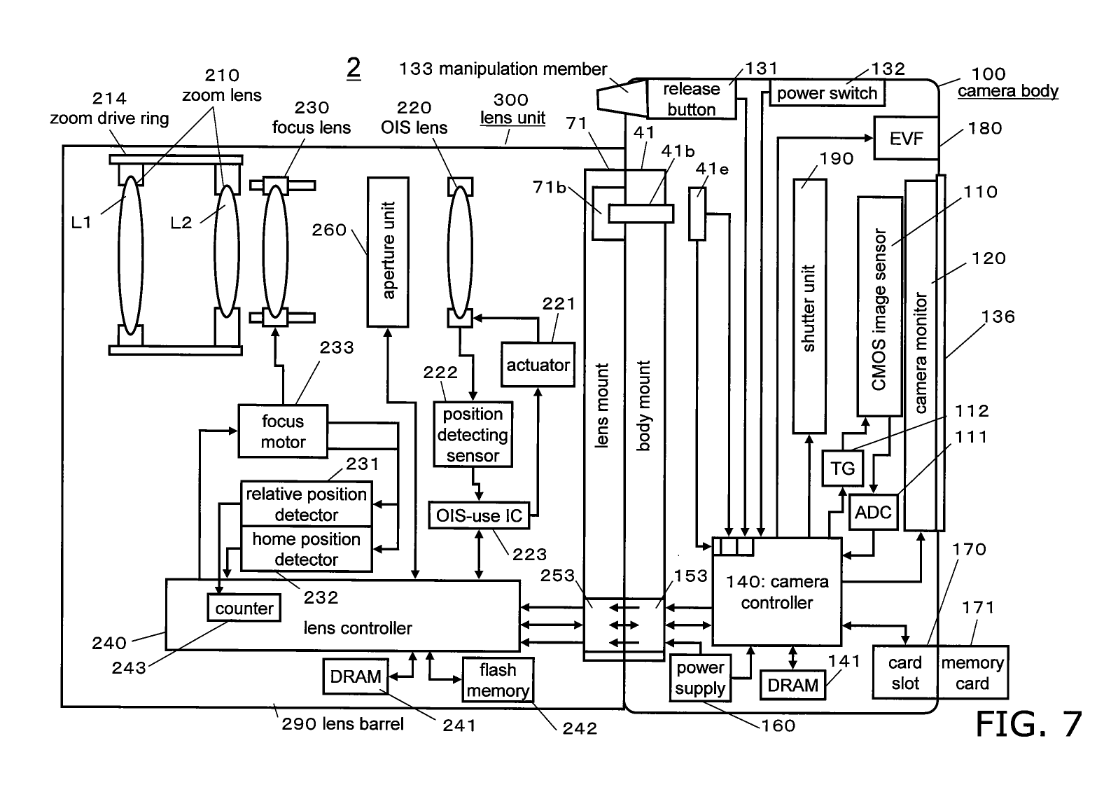

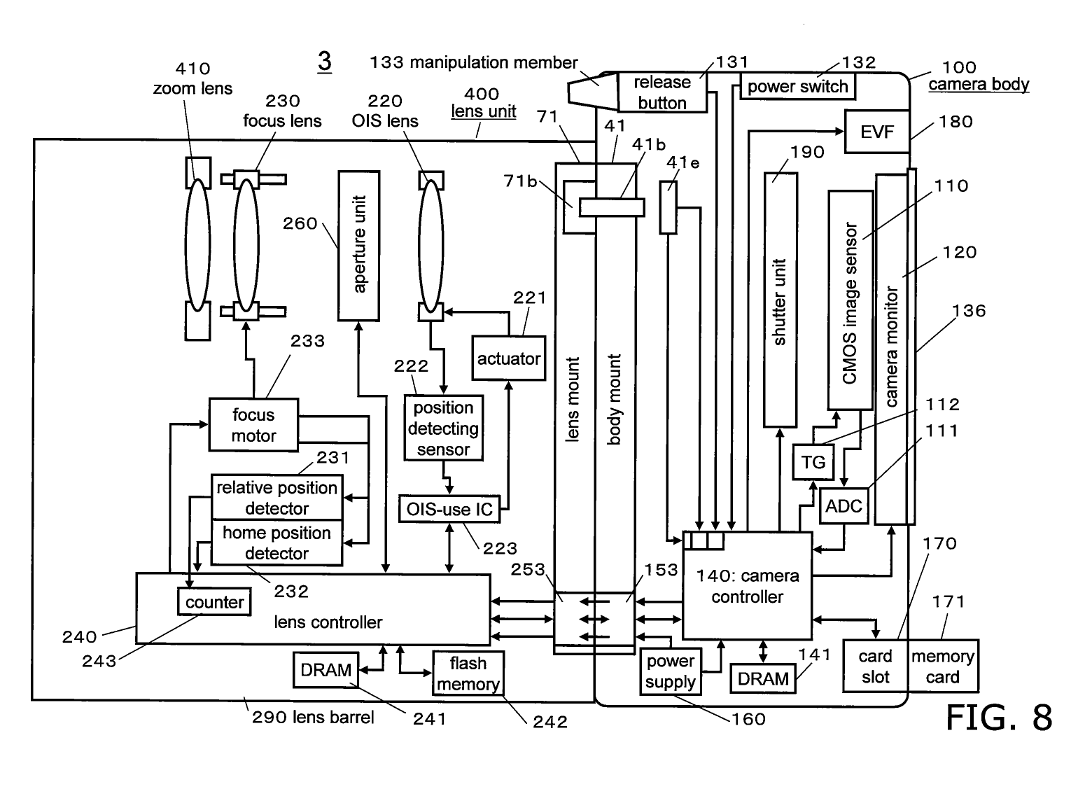

The manipulation member 133 is a rotary release switch provided around the release button 131 on the top face of the camera body 100, is biased so as to maintain its center position when not being operated, and can be rotated to the left and right, substantially around the release button 131, when turned by the user. Furthermore, since the manipulation member 133 is provided around the release button 131, it is in a location where it is easily operated by the index finger used by the user to press the release button 131, similar to the zoom manipulation member on a typical compact digital camera with a built-in zoom lens. With an interchangeable lens type of digital camera, however, the lens that is mounted is not necessarily an electrically zooming lens. Therefore, if the manipulation member 133 only has the function of a zoom manipulation member, then it will end up being a non-functioning manipulation member when a manual zoom lens or a single-focus lens (see the lens units 300 and 400 (discussed below) in FIGS. 7 and 8) is mounted.

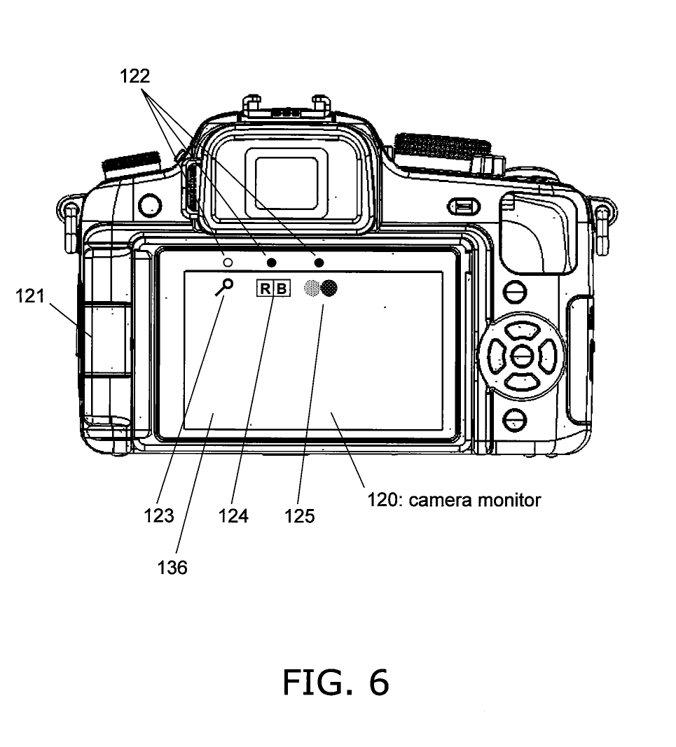

In view of this, in this embodiment, as shown in FIG. 6, icons or the like indicating a plurality of functions are displayed on the camera monitor 120, and the function of the manipulation member 133 is selected with the touch panel 136. FIG. 6 is a rear view of the camera body 100 in Embodiment 1. Examples of functions that can be assigned to the manipulation member 133 in this embodiment include zooming, color correction, and blur amount. Selecting a magnifying glass icon 123 assigns a zoom function to the manipulation member 133. Selecting a color correction icon 124 allows the hue of an image to be changed with the manipulation member 133 prior to its capture. Selecting the blur icon 125 allows the amount of blurring in the foreground and background to be controlled with the manipulation member 133. Furthermore, in this embodiment an LED display device 122 is provided, and the lighting of the LED display device 122 is controlled to correspond to the selected function. FIG. 6 shows a state in which the LED corresponding to the magnifying glass icon 123 is lit. The displayed functions are not limited to those given in this embodiment, and it should go without saying that various functions can be displayed and assigned.

The various manipulation components include buttons, levers, dials, touch panels, and so on, so long as they can be operated by the user. Also, the manipulation member 133 corresponds to an example of a camera body manipulation component.

The camera controller 140 shown in FIG. 3 controls the entire camera body 100, including the CMOS image sensor 110 and other such components. The camera controller 140 controls the shutter unit 190 so as to keep the shutter unit 190 open in a state in which the supply of power from the power supply 160 has been halted. The camera controller 140 also receives instructions from the various manipulation components 131 to 136. The camera controller 140 transmits signals for controlling the lens unit 200 through the body mount 41 and a lens mount 71 to a lens controller 240. The camera controller 140 also indirectly controls the various components of the lens unit 200. Specifically, the camera controller 140 controls the entire camera system 1. The camera controller 140 also receives various kinds of signals from the lens controller 240 via the body mount 41 and the lens mount 71. The camera controller 140 uses a DRAM 141 as a working memory during control operations and image processing operations. The camera controller 140 is an example of a camera body controller. The camera controller 140 is disposed on the main control board 142.

The card slot 170 shown in FIG. 3 allows the memory card 171 to be inserted. The card slot 170 controls the memory card 171 on the basis of control from the camera controller 140. More specifically, the card slot 170 stores image data on the memory card 171. The card slot 170 outputs image data from the memory card 171. It also stores moving picture data on the memory card 171. The card slot 170 outputs moving picture data from the memory card 171.

The memory card 171 is able to store the image data produced by the camera controller 140 in image processing. For instance, the memory card 171 can store uncompressed raw image files, compressed JPEG image files, or the like. Also, the memory card 171 can output internally stored image data or image files. The image data or image files outputted from the memory card 171 are subjected to image processing by the camera controller 140. For example, the camera controller 140 produces display-use image data by subjecting the image data or image files acquired from the memory card 171 to expansion, decompression, etc.

The memory card 171 is further able to store moving picture data produced by the camera controller 140 in image processing. For instance, the memory card 171 can store moving picture files compressed according to H.264/AVC, which is a moving picture compression standard. The memory card 171 can also output internally stored moving picture data or moving picture files. The moving picture data or moving picture files outputted from the memory card 171 are subjected to image processing by the camera controller 140. For example, the camera controller 140 produces display-use moving picture data by expanding the moving picture data or moving picture files acquired from the memory card 171. The memory card 171 is an example of a memory component. The memory component may be one that can be removably mounted to the camera body 100, such as the memory card 171, or may be one that is fixed to the camera system 1.

The power supply 160 shown in FIG. 3 supplies electrical power for use by the camera system 1. The power supply 160 may, for example, be a dry cell, or may be a rechargeable cell. The power supply 160 may also supply the camera system 1 with power from the outside, such as via a power cord.

The body mount 41 supports the removable lens unit 200. The body mount 41 can be mechanically and electrically connected with the lens mount 71 of the lens unit 200. Data and/or control signals can be sent and received between the camera body 100 and the lens unit 200 via the body mount 41 and the lens mount 71. More specifically, the body mount 41 and the lens mount 71 can send and receive data and/or control signals between the camera controller 140 and the lens controller 240. The body mount 41 supplies power received from the power supply 160 to the entire lens unit 200 via the lens mount 71.

More specifically, as shown in FIGS. 2 and 4, the body mount 41 includes a body mount contact hold component 152. The body mount 41 is either in a state of being mated with the lens mount 71 or a state of not being mated, depending on the rotational position relation around the optical axis of the lens mount 71 of the lens unit 200. Specifically, when the rotational position relation of the body mount 41 and the lens mount 71 is in a first state, the lens mount 71 is not mated with the body mount 41, and the lens mount 71 is able to move in the optical axis direction with respect to the body mount 41. When the body mount 41 is inserted into the lens mount 71 in the first state, and the lens mount 71 is rotated with respect to the body mount 41, the lens mount 71 mates with the body mount 41. The rotational position relation between the body mount 41 and the lens mount 71 here is in a second state. When the rotational position relation is in this second state, the body mount 41 mechanically supports the lens unit 200. The body mount 41 therefore needs to be strong, and the body mount 41 is preferably formed from metal. The body mount contact hold component 152 has a plurality of electrical contacts 153. The electrical contacts 153 are electrically connected to electrical contacts 253 of the lens mount 71, respectively. The electrical contacts 153 of the body mount 41 and the electrical contacts 253 of the lens mount 71 allow the body mount 41 and the lens mount 71 to be electrically connected. Also, the electrical contacts 153 of the body mount 41 and the electrical contacts 253 of the lens mount 71 allow power, data, and/or control signals to be sent and received. The body mount contact hold component 152 is disposed between the body mount 41 and the shutter unit 190. The body mount contact hold component 152 has an opening.

The shutter unit 190 shown in FIGS. 2 to 4 is what is known as a focal plane shutter. The shutter unit 190 is disposed between the body mount 41 and the CMOS image sensor 110. The shutter unit 190 can maintain an open state mechanically. The shutter unit 190 is controlled by the camera controller 140 so that its open state is mechanically maintained in a state in which the power to the camera body 100 has been shut off. The term “mechanically maintained” here is a concept meaning that an open state is maintained without the use of electrical power. For example, this can involve maintaining an open state with two objects being engaged or a permanent magnet.

The optical filter 114 shown in FIG. 4 has the function of an optical low-pass filter that eliminates the high-frequency component of the subject light. More specifically, the optical filter 114 separates a subject image formed by the lens unit 200 so that the resolution is coarser than the pitch of the pixels of the CMOS image sensor 110. In general, the CMOS image sensor 110 or other imaging element has an RGB color filter called a Bayer pattern, or a YCM complementary color filter, provided for each pixel. Therefore, if the resolution goes to one pixel, not only will a false color be generated, but if the subject has a repeating pattern, an unattractive moire will result. Furthermore, the optical filter 114 has an infrared cut filter function for cutting out infrared light with a wavelength of approximately 650 nm or higher.

The diaphragm 115 shown in FIG. 4 is disposed in front of the CMOS image sensor 110, and prevents dust from clinging to the CMOS image sensor 110. Also, any dust clinging to the diaphragm 115 itself is knocked off by the vibration of the diaphragm 115. More specifically, with the diaphragm 115, a thin, transparent sheet-like member is fixed to another member via a piezoelectric element. AC voltage is then applied to the piezoelectric element, which causes the piezoelectric element to vibrate, and this vibrates the sheet-like member.

As shown in FIG. 4, the camera body 100 comprises a built-in flash unit 191 and a hot shoe 161 to mount a flash. Moreover, as shown in FIG. 1, an inside subsidization light source 192 is disposed in the front of the camera body 100. The inside subsidization light source 192 is a light source for irradiating a subject when performing auto focusing and the subject is dark.

### 1-3: Configuration of Lens Unit

1-3-1: Lens Unit with which the Zoom Ratio of an Optical Image can be Varied by Electrical Zoom

As shown in FIG. 3, the lens unit 200 comprises an optical system, the lens controller 240, the lens mount 71, an aperture unit 260, a lens barrel 290, and a manipulation member 213 (see FIG. 1). The optical system of the lens unit 200 includes a zoom lens 210, an OIS lens 220, and a focus lens 230. The optical system is housed in the interior of the lens barrel 290.

The zoom lens 210 shown in FIG. 3 is used to change the zoom ratio of an optical image of a subject (hereinafter also referred to as a subject image) formed by the optical system of the lens unit 200, or in other words, to change the focal distance of the optical system. The zoom lens 210 is made up of one or more lenses. The zoom lens 210 includes a first lens group L1 and second lens group L2 of the optical system. The zoom lens 210 changes the focal distance by moving in a direction parallel to the optical axis AX of the optical system (see FIG. 4). A zoom drive ring 214 is provided around the outside of the zoom lens 210. A cam groove is formed in the inner face of the zoom drive ring 214, engages with cam followers (not shown) provided to the first lens group L1 and the second lens group L2, and allows the above-mentioned focal distance to change when the zoom drive ring 214 is rotationally driven. The zoom drive ring 214 is an example of a zoom driver that drives the focal distance, and the focal distance is determined according to the position after drive.

The zoom motor 211 shown in FIG. 3 is linked to the zoom drive ring 214, transmits the rotational force of the zoom motor 211 to the zoom lens 210, and moves the zoom lens 210 in the optical axis AX direction of the optical system. The zoom drive ring 214 has a cam mechanism, for example, and converts the rotation of the zoom drive ring 214 into rectilinear motion of the zoom lens 210. The zoom motor 211 and the zoom drive ring 214 together constitute an example of a zoom lens drive means. The zoom motor 211 encompasses a DC motor, a stepping motor, an ultrasonic motor, and all other such devices that generate rotational drive force.

A relative position detector 212 and a home position detector 215 are encoders that produce signals indicating the drive state of the zoom lens 210. The relative position detector 212 consists of a rotary slit plate and a photointerrupter for detecting the amount of rotation of the zoom motor 211, for example. The home position detector 215 is a home point detector that detects the home position of the zoom drive ring 214. The home position detector 215 consists of a photosensor, for example. The lens controller 240 recognizes that the zoom drive ring 214 is at the home point from a signal from the home position detector 215. At this point the lens controller 240 resets the value of a counter 243 that is provided internally. This counter 243 counts the extreme values of the photointerrupter signal outputted from the relative position detector 212. If an extreme value of a photointerrupter signal is detected when the zoom lens 210 is moved in a first direction parallel to the optical axis AX, the count is increased by 1. If an extreme value of a photointerrupter signal is detected when the zoom lens 210 has moved in a second direction that is the opposite to the first direction parallel to the optical axis AX, the count is decreased by 1. Thus, the lens controller 240 detects a relative position from the home position, which is an absolute position, which allows the lens controller 240 to ascertain the position of the zoom lens 210 in the optical axis AX direction by using the amount of rotation of the zoom drive ring 214 from its home position. The relative position detector 212 and the home position detector 215 are examples of a zoom lens position detection means. A zoom lens position detection means may be one that detects the position of the zoom lens directly, or one that detects the position of a mechanical member that is linked to the zoom lens.

For example, the zoom motor 211 may have a configuration comprising an L1-use zoom motor and an L2-use zoom motor. Specifically, the L1-use zoom motor is provided and motive force is transmitted to the zoom lens 210 by means of a screw and nut mechanism or the like, L1 of the zoom lens 210 is moved to a position in the optical axis AX direction, and the L2-use zoom motor is further provided so as to similarly move L2 to a position in the optical axis AX direction by means of a screw and nut mechanism or the like.

The OIS lens 220 shown in FIG. 3 is used to correct blurring of a subject image formed by the optical system of the lens unit 200. More specifically, the OIS lens 220 corrects blurring of the subject image caused by shake of the camera system 1. The OIS lens 220 moves in the direction of canceling out shake of the camera system 1, which reduces relative shake between the CMOS image sensor 110 and the subject image. More specifically, the OIS lens 220 moves in the direction of canceling out shake of the camera system 1, and thereby reduces blurring of the subject image on the CMOS image sensor 110. The OIS lens 220 is made up of one or more lenses. An actuator 221 is controlled by an OIS-use IC 223 and drives the OIS lens 220 within a plane that is perpendicular to the optical axis AX of the optical system.

The actuator 221 can be constituted by a magnet and a flat coil, for example. A position detecting sensor 222 detects the position of the OIS lens 220 within a plane that is perpendicular to the optical axis AX of the optical system. The position detecting sensor 222 can be constituted by a magnet and a Hall element, for example. The OIS-use IC 223 controls the actuator 221 on the basis of the detection result of the position detecting sensor 222 and the detection result of a gyro sensor or other such shake detector. The OIS-use IC 223 obtains the detection result of the shake detector from the lens controller 240. The OIS-use IC 223 also sends a signal to the lens controller 240 indicating the status of optical image blur correction processing.

The OIS lens 220 is an example of a blur corrector. Electronic blur correction that produces corrected image data on the basis of image data from a CCD may be used as a means for correcting blurring of the subject image caused by shaking of the camera system 1. Also, a configuration in which the CMOS image sensor 110 is driven within a plane that is perpendicular to the optical axis AX of the optical system may be used as a means for reducing the relative blurring between the subject image and the CMOS image sensor 110 caused by shaking of the camera system 1.

The focus lens 230 is used to change the focal state of the subject image formed by the optical system on the CMOS image sensor 110. The focus lens 230 is made up of one or more lenses. The focus lens 230 changes the focal state of the subject image by moving in a direction that is parallel to the optical axis AX of the optical system.

A focus motor 233 drives the focus lens 230 so that it moves forward and backward along the optical axis AX of the optical system under the control of the lens controller 240. Consequently, the focal state of the subject image formed by the optical system on the CMOS image sensor 110 can be changed. The focus motor 233 can drive the focus lens 230 independently of the drive of the zoom lens 210. More specifically, the focus motor 233 drives the focus lens 230 in the optical axis AX direction using the second lens group L2 as a reference. In other words, the focus motor 233 is able to change the relative distance between the second lens group L2 and the focus lens 230 in the optical axis AX direction. The focus lens 230 and the focus motor 233 move in the optical axis AX direction along with the second lens group L2. Therefore, when the second lens group L2 moves in the optical axis AX direction due to zooming, the focus lens 230 and the focus motor 233 also move in the optical axis AX direction. Also, even in a state in which the second lens group L2 is stationary in the optical axis AX direction, the focus motor 233 can drive the focus lens 230 in the optical axis AX direction using the second lens group L2 as a reference. The focus motor 233 can be a DC motor, a stepping motor, a servo motor, an ultrasonic motor, or the like. The focus motor 233 is an example of a focus lens drive means.

The relative position detector 231 and the home position detector 232 shown in FIG. 3 are encoders that produce signals indicating the drive state of the focus lens 230. The relative position detector 231 has a magnetic scale and a magnetic sensor, detects a change in magnetism, and outputs a signal corresponding to the change in magnetism. An example of a magnetic sensor is an MR sensor. The home position detector 232 is a home point detector that detects the home position of the focus lens 230 with respect to the second lens group L2. The home position detector 232 consists of a photosensor, for example. The lens controller 240 recognizes that the focus lens 230 is at its home point from a signal from the home position detector 232. At this point the lens controller 240 resets the value of a counter 243 that is provided internally. This counter 243 counts the extreme values of magnetic changes by using signals outputted from the relative position detector 231. If an extreme value for magnetic change is detected when the focus lens 230 moves in a first direction that is parallel to the optical axis AX, the count is increased by 1. If an extreme value for magnetic change is detected when the focus lens 230 moves in a second direction that is parallel to the optical axis AX, the count is decreased by 1. Thus, the lens controller 240 detects a relative position from the home position, which is an absolute position, and thereby ascertains the position of the focus lens 230 in the optical axis AX direction with respect to the second lens group L2. As discussed above, the lens controller 240 is able to ascertain the position of the second lens group L2 in the optical axis AX direction within the lens unit 200. Therefore, the lens controller 240 is able to ascertain the position of the focus lens 230 in the optical axis AX direction within the lens unit 200. The relative position detector 231 and the home position detector 232 are examples of a focus lens position detection means. A focus lens position detection means may be one that detects the position of the focus lens directly, or one that detects the position of a mechanical member that is linked to the focus lens.

The aperture unit 260 shown in FIG. 3 is a light quantity adjusting member that adjusts the quantity of light transmitted by the optical system. The aperture unit 260 has aperture vanes that can block part of the light rays transmitted by the optical system, and an aperture driver that adjusts the quantity of light by driving the aperture vanes and varying the amount of blockage thereof. The camera controller 140 directs the operation of the aperture unit 260 on the basis of the how much light has been received by the CMOS image sensor 110, whether still picture imaging or moving picture imaging is being performed, whether or not an aperture value has been set preferentially, and so forth.

The manipulation member 213 shown in FIGS. 1 and 3 is a sliding lever switch provided to the surface of the lens unit 200, is biased so as to maintain its center position when not being operated, and can be slid in the peripheral direction of the lens barrel 290. The manipulation member 213 is usually assigned the function of electrical zooming of the lens unit 200. Specifically, when the user operates the manipulation member 213, the lens controller 240 detects this operation and drives the zoom lens 210 according to the amount of operation. This allows zooming to be performed corresponding to the operation by the user. The manipulation member 213 may also be assigned another function by control from the camera controller 140 of the mounted camera body 100. Specifically, the lens controller 240 may perform other control according to the operation of the manipulation member 213, through control from the camera controller 140. For example, the configuration may be such that the user can focus manually with the manipulation member 213 by controlling the drive of the focus lens 230.

The lens controller 240 shown in FIG. 3 controls the entire lens unit 200, such as the OIS-use IC 223 and the focus motor 233, on the basis of control signals from the camera controller 140. The lens controller 240 also receives signals from the relative position detector 212, the OIS-use IC 223, the relative position detector 231, home position detector 232, and so forth, and sends these to the camera controller 140. The lens controller 240 exchanges signals with the camera controller 140 via the lens mount 71 and the body mount 41. The lens controller 240 uses a DRAM 241 as a working memory during control. Also, a flash memory 242 stores programs and parameters used in control by the lens controller 240. More specifically, various information related to the lens unit 200 (lens information) is stored in the flash memory 242. This lens information includes various information related to the lens such as, for example, information related to the model used for identifying the lens unit 200 (lens identification information), such as the manufacturer of the lens unit 200, the manufacture date, the model number, an ID, the software version installed in the lens controller 240, and firmware updates; information related to whether or not the lens unit 200 is equipped with means for correcting image blurring, such as the OIS lens 220; when there is a means for correcting image blurring, information related to a model number; information related to a detection function, such as a sensitivity; information related to a correction function, such as the maximum angle that can be corrected (lens-side correction performance information); and information related to the software version for performing blur correction. Lens information further includes information related to the power consumption required to drive the blur corrector (lens-side power consumption information), and information related to the drive method of the blur corrector (lens-side drive method information). The flash memory 242 is also able to store information sent from the camera controller 140.

As shown in FIG. 3, the lens mount 71 has the electrical contacts 253. The body mount 41 and the lens mount 71 can be electrically connected by the electrical contacts 153 of the body mount 41 and the electrical contacts 253 of the lens mount 71. Also, the electrical contacts 153 of the body mount 41 and the electrical contacts 253 of the lens mount 71 allow power, data, and/or control signals to be sent and received.

1-3-2: Lens Unit with which the Zoom Ratio of an Optical Image can be Varied Manually

FIG. 7 is a simplified cross section of a camera system 2 comprising the camera body 100 and a lens unit 300 that allows manual zooming As shown in FIG. 7, the lens unit 300 differs from the lens unit 200 in that it is not provided with the relative position detector 212, the home position detector 215, or the manipulation member 213. With this lens unit 300, the lens barrel 290 is rotated to change the distance between the first lens group L1 and the second lens group L2, thus allowing zooming to be performed.

1-3-3: Lens Unit with which the Zoom Ratio of an Optical Image is Fixed

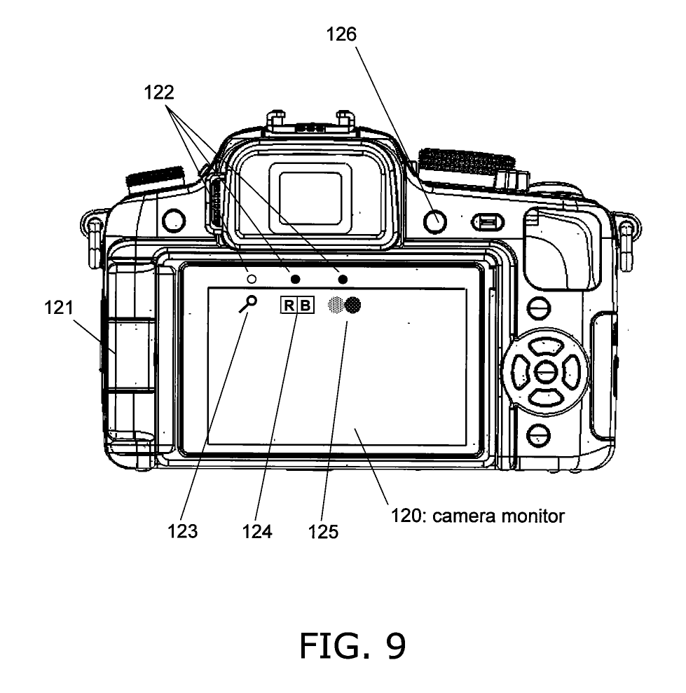

FIG. 8 is a simplified cross section of a camera system 3 comprising the camera body 100 and a lens unit 400 that is a single-focus lens. As shown in FIG. 9, since it is single-focus, the lens unit 400 differs from the lens unit 300 in FIG. 7 in that the zoom lens 210 is not provided, and a lens group 410 is provided.

### 2: Zoom Operation

2-1: Attachment and Removal of Interchangeable Lens to and from Camera Body

A lens locking pin 41b (see FIG. 3) is provided to the body mount 41 of the camera body 100 so as to be capable of protruding and being pushed in. When the lens unit 200 has been mounted, this lens locking pin 41b mates with a locking pin mating hole 71b of the lens mount 71, which prevents the lens unit 200 from rotating. Furthermore, the lens locking pin 41b is biased in the protruding direction by a lens locking pin biasing spring (not shown) in order to maintain its protruding state.

The lens attachment and removal member 41c shown in FIGS. 1 to 3 is provided so as to be capable of protruding and being pushed in. The lens attachment and removal member 41c is mechanically linked to the lens locking pin 41b. When the lens unit 200 is to be removed, the user pushes the lens attachment and removal member 41c into the interior of the camera body 100. When this happens, the lens attachment and removal member 41c is pushed in against the biasing force of a biasing spring (not shown) that biases the lens attachment and removal member, and the lens locking pin 41b is also pushed in. As a result, the lens locking pin 41b is disengaged from the locking pin mating hole 71b of the lens mount 71, and the lens unit 200 is able to rotate with respect to the camera body 100. The user can then remove the lens unit 200 from the camera body 100 at the position where the rotational position relation between the body mount 41 and the lens mount 71 is in a first state. The lens locking pin 41b returns to its protruding state at the position where the rotational position relation between the body mount 41 and the lens mount 71 is in this first state.

The lens attachment and removal detection switch 41e shown in FIG. 3 can detect that the lens attachment and removal member 41c has been operated and that the lens locking pin 41b has been pushed in. More specifically, the lens attachment and removal detection switch 41e is operated when the lens attachment and removal member 41c is pushed in or when the lens locking pin 41b is pushed in. When the lens unit 200 is removed from the camera body 100, the lens locking pin 41b returns to its protruding state, and the operation of the lens attachment and removal detection switch 41e is released.

When the lens unit 200 is to be mounted to the camera body 100, the user turns the lens unit 200 from the position at which the rotational position relation between the body mount 41 and the lens mount 71 is in the first state to the position of the second state. The lens locking pin 41b is protruding in the first state, but when the lens unit 200 is turned from the first state to the second state, this lens locking pin 41b hits the lens mount 71 and is pushed in. In the second state, the lens locking pin 41b mates with the locking pin mating hole 71b of the lens mount 71 and enters its protruding state. When the lens unit 200 is to be mounted, the lens attachment and removal detection switch 41e is operated in conjunction with this operation of the lens locking pin 41b.

As discussed above, the lens attachment and removal detection switch 41e can detect attachment and removal of the lens unit 200.

### 2-2: Recognition of Lens Unit by Camera Body

When the lens attachment and removal detection switch 41e is operated and attachment or removal of a lens is detected, the camera controller 140 begins exchanging data and/or control signals with the lens controller 240. At this point, the camera controller 140 identifies whether the lens is compatible with electrical zooming (as with the lens unit 200), whether the lens has manual zoom (such as with the lens unit 300), or whether it is a single-focus lens (as with the lens unit 400), from information related to the model used for identifying the mounted lens unit (lens identification information).

When the lens unit 200 is mounted, since it is compatible with electrical zooming, electric zooming will be possible with the manipulation member 133 of the camera body 100. Therefore, as shown in FIG. 6, when the user operates the touch panel 136 to select the magnifying glass icon 123, the camera controller 140 detects this and assigns an electrical zooming function to the manipulation member 133. When the user operates the manipulation member 133 after this, the camera controller 140 detects this operation and directs the lens controller 240 to drive the zoom lens 210 according to the operation amount. The lens controller 240 drives the zoom lens 210 under a directive from the camera controller 140. Consequently, electrical zooming by the user can be performed by operating the manipulation member 133. Zooming can also be performed with the manipulation member 213 of the lens unit 200, but a directive may be sent to the lens controller 240 to permit manual autofocus with the manipulation member 213 of the lens unit 200. If this is done, the user will be able not only to perform electrical zooming by operating the manipulation member 133, but also to perform manual focusing by operating the manipulation member 213.

If there is no function assigned to the manipulation member 213, since the manipulation member 133 is provided to the camera body 100 for performing electrical zooming of the lens unit 200, the manipulation member 213 of the lens unit 200 need not be provided.

The lens unit 200 described through reference to FIGS. 1 to 6 above is a lens unit that is capable of electrical zooming, but if the lens unit 200 is not compatible with electrical zooming, that is, if it has manual zoom (the lens unit 300) or is a single-focus lens (the lens unit 400), then electrical zooming cannot be performed with the manipulation member 133 of the camera body 100. However, what is known as an electronic zooming function will be possible, with which part of a subject image formed by the CMOS image sensor 110 is continuously cropped. In view of this, as shown in FIG. 6, when the user selects the magnifying glass icon 123, electronic zoom by operation of the manipulation member 133 will be permitted. More specifically, when the user operates the manipulation member 133, the camera controller 140 detects this and changes the zoom ratio in the electronic zoom processing according to the amount of operation. Consequently, electronic zooming by the user can be performed by operating the manipulation member 133. Similarly, even when the lens unit 200 of Embodiment 1 that is compatible with electrical zooming is mounted, it will be possible to permit electronic zooming after reaching the electrical zoom end (telephoto end).

### 3: Effect, Etc.

As discussed above, in this embodiment, the camera system 1 comprises the lens unit 200 and the camera body 100, which has the body mount 41, the manipulation member 133, and the camera controller 140. The lens unit 200 is able to change the zoom ratio of an optical image electrically. The body mount 41 allows the lens unit 200 to be attached and removed. The manipulation member 133 is self-centering. The camera controller 140 controls the lens unit 200 so that in a state in which the lens unit 200 has been mounted to the body mount 41, the zoom ratio of an optical image is changed electrically according to the operation of the manipulation member 133.

Consequently, when the lens unit 200, which is a an interchangeable lens capable of electrical zooming, is mounted, electrical zooming of the lens unit 200 can be performed by operating the manipulation member 133 provided to the camera body 100. Accordingly, there is no loss of camera body function when performing electrical zooming. Specifically, since an existing manipulation member to which another function has been assigned is not used, there is no loss of the function of the camera body. Also, using the self-centering manipulation member 133 makes it easier for the user to smoothly and intuitively adjust the zoom.

Furthermore, the camera body 100 has the CMOS image sensor 110. The CMOS image sensor 110 produces image data by converting an optical image produced by the lens unit 200 into an electrical signal. The camera controller 140 is able to perform electronic zoom processing for cropping part of the image data. The camera controller 140 controls the lens unit 200 so as to change the zoom ratio of the optical image electrically according to the operation of the manipulation member 133, and so that after the lens unit 200 reaches the optical telephoto end, the zoom ratio of electronic zoom processing of the image data is changed continuously according to the operation of the manipulation member 133.

Since further zooming can be performed by electronic zooming after the lens unit 200 has reached the optical telephoto end of electrical zooming by operating the manipulation member 133, the user does not have to switch from electrical zooming to electronic zooming, etc., and this improves the user's convenience.

Also, in this embodiment, the camera system 2 comprises the lens unit 300 or lens unit 400 and the camera body 100 that has the body mount 41, the manipulation member 133, the CMOS image sensor 110, and the camera controller 140. The lens unit 300 allows the zoom ratio of the optical image to be varied manually. The lens unit 400 has a fixed optical image zoom ratio. The body mount 41 allows the lens unit 300 or the lens unit 400 to be attached and removed. The manipulation member 133 is self-centering. The CMOS image sensor 110 produces image data by converting an optical image produced by the lens unit 300 or the lens unit 400 into an electrical signal. The camera controller 140 can perform electronic zoom processing to crop part of the image data in a state in which the lens unit 300 or the lens unit 400 has been mounted to the body mount 41. Also, the camera controller 140 controls so that the zoom ratio of electronic zoom processing of the image data is changed continuously according to the operation of the manipulation member 133.

Consequently, when the lens unit 300 or 400, which is an interchangeable lens with which electrical zooming is impossible, is mounted, electronic zooming can be performed by operating the manipulation member 133 provided to the camera body 100. Accordingly, there is no loss of camera body function when performing electrical zooming. Specifically, since an existing manipulation member to which another function has been assigned is not used, there is no loss of the function of the camera body.

Also, in this embodiment, the camera body 100 comprises the touch panel 136 and the camera monitor 120. The camera monitor 120 is able to display icons indicating a plurality of functions including changing the zoom ratio of an optical image. One of these functions can be selected according to the operation of the touch panel 136. The selected function is assigned to the self-centering manipulation member 133.

Consequently, a function can be selected, and another function can be assigned to the manipulation member 133 even when a single-focus lens or a manual zoom lens with which electrical zooming is impossible has been mounted, so the manipulation member 133 does not go to waste. It can be assigned other operations in addition to electrical zooming or electronic zooming, which makes the product more convenient to use. Also, providing the touch panel 136 on the camera monitor 120 means that less space is taken up, and it is easier to select other functions.

Also, in this embodiment, the camera body 100 allows the mounting of the lens unit 200, with which the zoom ratio of an optical image can be changed electrically, and comprises the body mount 41, the manipulation member 133, and the camera controller 140. The body mount 41 allows the lens unit 200 to be attached and removed. The manipulation member 133 is self-centering. The camera controller 140 controls the lens unit 200 so that in a state in which the lens unit 200 has been mounted to the body mount 41, the zoom ratio of an optical image is changed electrically according to the operation of the manipulation member 133.

Consequently, when the lens unit 200, which is an interchangeable lens capable of electrical zooming, is mounted, electrical zooming of the lens unit 200 can be performed by operating the manipulation member 133 provided to the camera body 100. Accordingly, when performing electrical zooming, there is no loss of camera body function. Specifically, since an existing manipulation member to which another function has been assigned is not used, there is no loss of the function of the camera body. Also, using the self-centering manipulation member 133 makes it easier for the user to smoothly and intuitively adjust the zoom.

Furthermore, the lens unit 300, with which the zoom ratio of an optical image can be varied manually, or the lens unit 400, with which the zoom ratio of an optical image is fixed, can be mounted to the camera body 100, and the camera body 100 comprises the CMOS image sensor 110. The CMOS image sensor 110 produces image data by converting an optical image produced by the lens unit 300 or the lens unit 400 into an electrical signal. The camera controller 140 is able to perform electronic zoom processing for cropping part of the image data in a state in which the lens unit 300 or the lens unit 400 has been mounted to the mount, and the zoom ratio of electronic zoom processing of image data is continuously varied according to the operation of the manipulation member 133.

Consequently, when an interchangeable lens that allows electrical zooming has been mounted, electrical zooming is performed with the manipulation member 133, and when an interchangeable lens that does not allow electrical zooming has been mounted, electronic zooming can be performed with the manipulation member 133. Accordingly, the manipulation member 133 does not go to waste and can be put to good use even when an interchangeable lens that does not allow electrical zooming is mounted.

Also, in this embodiment, the camera body 100 allows the mounting of the lens unit 300, with which the zoom ratio of an optical image can be varied manually, or the lens unit 400, which is a lens with which the zoom ratio of an optical image is fixed, and comprises the body mount 41, the manipulation member 133, the CMOS image sensor 110, and the camera controller 140. The body mount 41 allows the lens unit 200 to be attached and removed. The manipulation member 133 is self-centering. The CMOS image sensor 110 produces image data by converting an optical image produced by the lens unit 300 or the lens unit 400 into an electrical signal. The camera controller 140 can perform electronic zoom processing for cropping part of the image data in a state in which the lens unit 300 or the lens unit 400 has been mounted to the body mount 41. The camera controller 140 also controls so that the zoom ratio of electronic zoom processing of the image data is varied continuously according to the operation of the manipulation member 133.

Consequently, when the lens unit 300 or 400, which is an interchangeable lens with which electrical zooming is impossible, is mounted, electronic zooming can be performed by operating the manipulation member 133 provided to the camera body 100. Accordingly, there is no loss of camera body function when performing electronic zooming. Specifically, since an existing manipulation member to which another function has been assigned is not used, there is no loss of the function of the camera body.

### Other Embodiments

Embodiment 1 was described above as an example of the technology disclosed herein, but the technology of this disclosure is not limited to this, and can also be applied to embodiments entailing suitable changes, substitutions, additions, eliminations, and so forth. Also, new embodiments can be created by combining the constituent elements described in Embodiment 1 above.

In view of this, non-exhaustive examples of other embodiments will now be given.

(1) In FIG. 6, a plurality of functions were displayed on the camera monitor 120, the function of the manipulation member 133 was selected with the touch panel 136, and the selected function was displayed lit up on the LED display device 122. However, since the camera monitor 120 is a liquid crystal display device, various display configurations are possible. In view of this, rather than providing the LED display device 122 to display the selected function, the selected icon may be highlighted by changing the transparency or coloration of the display icons 123 to 125 other than the one selected.

(2) FIG. 9 shows another embodiment for achieving the same function in a camera that does not have the touch panel 136 from Embodiment 1. The LED display device 122 and the various function icons 123 to 125 on the camera monitor 120 are displayed the same as in FIG. 6. However, since the camera in FIG. 9 does not have a touch panel, the various function icons displayed on the camera monitor 120 cannot be selected with a finger. For this reason, a selector switch 126 is provided. The selector switch 126 has a “push-switch” configuration, and every time the selector switch 126 is operated, the camera controller 140 detects this and changes the selected function sequentially. For example, every time the selector switch 126 is operated, the selected function changes from the function icon 123 to 124 to 125, and when operated again returns to 123. Therefore, the function of the manipulation member 133 can be selected in a way that is simple and easy for the user to understand by lighting the LED display device and displaying on the camera monitor 120.

It should go without saying that the LED display device 122 may be eliminated as in another Embodiment 1, and the selected icon display highlighted by changing the transparency or coloration of the icons other than the one selected.

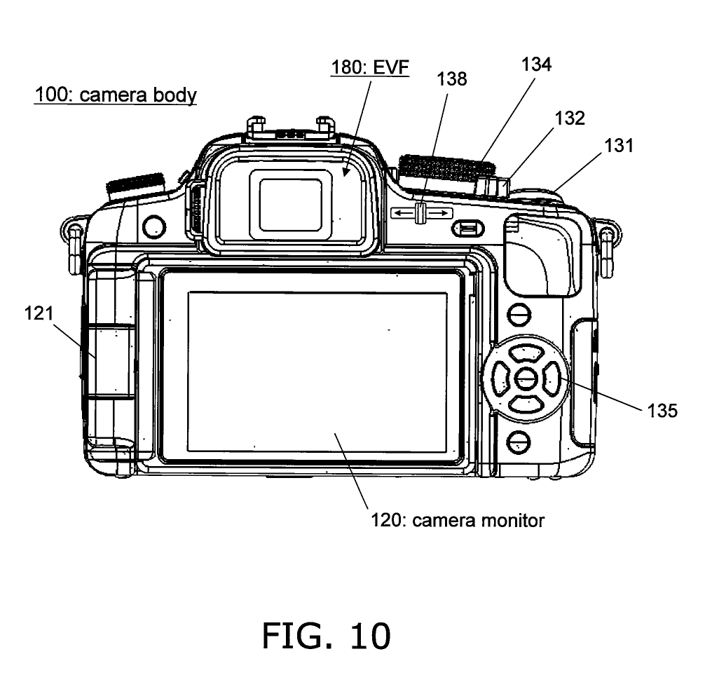

(3) In Embodiment 1, the manipulation member 133 was described as an example of a camera body manipulation component, but the camera body manipulation component need only be self-centering. Therefore, the camera body manipulation component is not limited to being the manipulation member 133. However, if the manipulation member 133 is used as the camera body manipulation component, since it is provided around the release button 131, it does not take up much space. Also, this component is not limited to a configuration that allows rotational operation as with the manipulation member 133, and may, for example, have a configuration such as the manipulation member 138 shown in FIG. 10. The manipulation member 138 shown in FIG. 10 is biased so as to be able to move in a straight line in the left and right direction (see the arrows), and to be maintained in its center position (the middle position of the straight line) when not being operated.

Embodiments were described above as examples of the technology of this disclosure. To this end, the appended drawings and detailed description were provided.

Therefore, the constituent elements shown in the appended drawings and mentioned in the detailed description may include not only the constituent elements that are essential to solving the problem, but also constituent elements that are not essential to solving the problem, in order to illustrate examples of the above-mentioned technology. Accordingly, these non-essential constituent elements should not be immediately construed as being essential just because they are shown in the appended drawings and mentioned in the detailed description.

Also, the above embodiments were given to illustrate examples of the technology in this disclosure, so various modifications, substitutions, additions, eliminations, and so forth are possible within the scope of the patent claims or their equivalents.

### INDUSTRIAL APPLICABILITY

This disclosure can be applied to camera systems. More specifically, it can be applied to digital still cameras, movie cameras, and the like.

### REFERENCE SIGNS LIST

1 camera system
100 camera body
41 body mount
41b lens locking pin
41c lens attachment and removal member
41e lens attachment and removal detection switch
71 lens mount
71b locking pin mating hole
110 CMOS image sensor
111 A/D converter
112 timing generator
113 CMOS circuit board
114 optical filter
115 diaphragm
120 camera monitor
121 hinge
122 LED display device
126 selector switch
131 release button
132 power switch
133 manipulation member
134 rotary manipulation member
135 cross key
136 touch panel
140 camera controller
141, 241 DRAM
142 main circuit board
152 body mount contact hold component
153, 253 electrical contact
160 power supply
161 hot shoe
170 card slot
171 memory card
180 electronic viewfinder (EVF)
181 EVF-use liquid crystal monitor
182 EVF-use optical system
183 eyepiece
190 shutter unit
191 built-in flash unit 192 inside subsidization light source
200 lens unit
210 zoom lens
211 zoom motor
212 relative position detector
213 manipulation member
214 zoom drive ring
215 home position detector
220 OIS lens
221 actuator
222 position detecting sensor
223 OIS-use IC
230 focus lens
231 relative position detector
232 home position detector
233 focus motor
240 lens controller
242 flash memory
290 lens barrel
300 lens unit
400 lens unit

What is claimed is:

1. A camera system comprising:
a lens unit with which the zoom ratio of an optical image is varied electrically; and
a camera body including:
a mount configured to allow the lens unit to be attached and removed;
a self-centering camera body manipulation component configured to be operated by a user; and
a camera body controller operable to control the lens unit so as to vary the zoom ratio of an optical image electrically according to an operation of the camera body manipulation component in a state in which the lens unit has been mounted to the mount.

2. A camera system comprising:
a lens unit with which the zoom ratio of an optical image is fixed or is varied manually; and
a camera body including:
a mount configured to allow the lens unit to be attached and removed;
a self-centering camera body manipulation component configured to be operated by a user;
an imaging element operable to produce image data by converting an optical image produced by the lens unit into an electrical signal; and
a camera body controller operable to perform electronic zooming to crop part of the image data, and to continuously vary the zoom ratio of the electronic zooming of the image data according to an operation of the camera body manipulation component in a state in which the lens unit has been mounted to the mount.

3. The camera system according to claim 1,
wherein the camera body has an imaging element operable to produce image data by converting an optical image produced by the lens unit into an electrical signal,
the camera body controller is operable to perform electronic zooming to crop part of the image data, and
the camera body controller is operable to control the lens unit to vary the zoom ratio of an optical image electrically according to an operation of the camera body manipulation component, and to continuously vary the zoom ratio of the electronic zooming of the image data according to the operation of the camera body manipulation component after the lens unit has reached the optical telephoto end.

4. The camera system according to claim 1, the camera body further comprising a selector switch and a monitor, wherein:
marks indicating a plurality of functions, including changing the zoom ratio of an optical image, are displayed on the monitor, and at least one of these functions is selected according to the operation of the selector switch; and
the selected function is assigned to the self-centering camera body manipulation component.

5. The camera system according to claim 4,
wherein the selector switch is a touch panel provided on the monitor.

6. A camera body to which can be mounted a lens unit with which the zoom ratio of an optical image can be varied electrically, said camera body comprising:
a mount configured to allow the lens unit to be attached and removed;
a self-centering camera body manipulation component configured to be operated by a user; and
a camera body controller operable to control the lens unit to vary the zoom ratio of an optical image electrically according to an operation of the camera body manipulation component in a state in which the lens unit has been mounted to the mount.

7. A camera body to which can be mounted a lens unit with which the zoom ratio of an optical image is fixed or can be varied manually, said camera body comprising:
a mount configured to allow the lens unit to be attached and removed;
a self-centering camera body manipulation component configured to be operated by a user;
an imaging element operable to produce image data by converting an optical image produced by the lens unit into an electrical signal; and
a camera body controller operable to perform electronic zooming to crop part of the image data, and to continuously vary the zoom ratio of the electronic zooming of the image data according to an operation of the camera body manipulation component, in a state in which the lens unit has been mounted to the mount.

8. The camera body according to claim 6, wherein:
a lens unit, with which the zoom ratio of an optical image is fixed or is varied manually, can be attached to and removed from the mount of the camera body,
the camera body comprises an imaging element operable to produce image data by converting an optical image produced by the lens unit into an electrical signal, and
in a state in which the lens unit, with which the zoom ratio of an optical image is fixed or the zoom ratio of the optical image is varied manually, has been mounted to the mount of the camera body, electronic zooming is performed to crop part of the image data, and the zoom ratio of the electronic zooming of the image data is continuously varied according to the operation of the camera body manipulation component.

9. The camera system according to claim 2, the camera body further comprising a selector switch and a monitor, wherein:
marks indicating a plurality of functions, including changing the zoom ratio of an optical image, are displayed on the monitor, and at least one of these functions is selected according to the operation of the selector switch; and
the selected function is assigned to the self-centering camera body manipulation component.

10. The camera system according to claim 3, the camera body further comprising a selector switch and a monitor, wherein:
marks indicating a plurality of functions, including changing the zoom ratio of an optical image, are displayed on the monitor, and at least one of these functions is selected according to the operation of the selector switch; and
the selected function is assigned to the self-centering camera body manipulation component.
